(19) United States
(12) Patent Application Publication
(10) Pub. No.: US 2020/0331169 A1
(43) Pub. Date: Oct. 22, 2020

(54) Heat and Energy Integrated Continuous Process for Plastic Waste Recovery

(71) Applicant: Sprint Environmental Services, LLC, SUGAR LAND, TX (US)

(72) Inventors: Robert G. Roodman, Katy, TX (US); Premal Shah, Sugar Land, TX (US)

(21) Appl. No.: 16/851,682

(22) Filed: Apr. 17, 2020

Related U.S. Application Data
(60) Provisional application No. 62/836,584, filed on Apr. 19, 2019.

(51) Int. Cl. B29B 17/02; C10J 3/78

(52) U.S. Cl. CPC B29B 17/02; C10J 3/78; B01J 3/008; C10J 2300/0946; C10J 2300/1643; B29B 2017/0293

(57) ABSTRACT

Improvements relate to a heat and energy integrated method and apparatus for plastic waste recovery having supercritical liquefaction. A volume of plastic waste is processed to produce a plastic waste stream. A reaction unit is utilized for adsorbing the plastic with a solvent having at least water, plus heating and pressurizing the plastic waste stream with the solvent into a supercritical extraction state for converting the plastic waste stream into a mixture fluid stream of a supercritical nature within the reaction unit. The mixture fluid stream may be cycled proximate to the outlet from the reaction unit via periodically letting the pressure down, and then letting the pressure recover. A volume of inert solids are removed from the mixture fluid stream thereby creating a remaining combined gases and liquids fluid stream. Power is recovered from the remaining combined gases and liquids fluid stream. And, volumes of water, gas and oil are separated from the combined gases and liquids fluid stream.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### BACKGROUND

Technical field: The subject matter generally relates to processes and techniques for recovery/recycling of plastic waste.

There is a worldwide problem of plastic wastes accumulating in landfills and oceans. The problem of plastic waste accumulation is overwhelming due to the long history of plastic production without any recycling, and the current halt of recovery of plastics in other countries. Therefore a need exists for a robust process able to handle mixed wastes, and convert those wastes into products in a process that has low operating costs and is economically viable in the marketplace.

As described in publications and multiple patents many people in academia and in many companies are working on ways to recycle or eliminate plastic waste. Approaches previously used by various companies include pyrolysis, methanolysis, supercritical water extraction, with and without cosolvents, and catalysis. And others will also eventually emerge because of the vast amount of plastic waste to be dealt with.

More complete information on the size of the problem is presented in the Background section of the Chen, et. al. US application publication no. US2019/0322832.

Pyrolysis is one of the first approaches to resolution of the problem. In pyrolysis the waste plastic is fed in a reduced size form into a pyrolysis reactor. There it is burned without air, or oxygen, introduced in a kiln, retort, or other vessel, in either a batch or continuous manner. The application of high temperature causes the plastic waste to melt, and then begin cracking reactions to produce water, gases, oils, chars, and inert solids residues. Cracking begins above 600F., and continues through the end of the reactor, which is run above 1700F. The gases are light hydrocarbons, oils are light and heavy distillate, down to gas oils, and the chars are carbonaceous solids. These must be removed along with the inerts to prevent fouling of the reactor and downstream recovery equipment, which may include condensers, distillation equipment, filters, etc. The pyrolysis products are not capped, nor oxygenated. The gases may be used as fuel gases, and the other products may be sold to refineries.

Methanolysis is a very recent approach to the solution of the plastic waste problem. It differs from both extraction and pyrolysis, in that it does not attempt to use pressure and temperature, in the pyrolysis process, or pressure and temperature in the presence of a solvent like the extraction process. The methanolysis reaction is a transesterification reaction used to convert polymers back to pure monomers for reuse in the manufacture of new plastics, including the polyester polymers. The process operates at moderate temperatures and uses methanol as the operative reagent to do the reaction. Other technology solutions previously mentioned above that recover the plastics into monomers or other molecular products are likely more complex than the process of interest in this application, described in the next paragraph, and cost more to build and to operate.

Prior disclosed plants such as those disclosed in International/PCT publication nos. WO2016/197180 and WO2009/015409 and U.S. Pat. No. 8,579,996 having adsorber/reactors get very thick walled as the operating pressure goes up which adds to the expense of any facility.

Use of an adsorption device, with less water usage, and improved mixing method are described in U.S. Pat. Nos. 8,057,666 and 10,421,052. Those skilled in the art of using extruders know they come with limitations in terms of total throughput in lbs./hr., up to several thousand pounds per hour maximum, versus multiple tens or hundreds of thousand pounds per hour for other processes. Extruders are also very expensive pieces of equipment, especially when operating at thousands of pounds of pressure. The needs to establish good sealing mechanisms for these devices, and the abrasion resistance needed to handle the plastic additives necessitate the use of exotic metals, and require close tolerance manufacturing techniques and extruder elements, that add to the expense such a device.

### BRIEF SUMMARY

The embodiments disclosed herein relate to heat and energy integrated (and under normal conditions continuous) processes and/or apparatus for plastic waste recovery utilizing supercritical extraction. A volume of plastic waste is processed to produce a plastic waste stream. A reaction unit is utilized for adsorbing the plastic with a solvent having at least water, plus heating and pressurizing the plastic waste stream with the solvent into a supercritical extraction state for converting the plastic waste stream into a mixture fluid stream of a supercritical nature within the reaction unit. The mixture fluid stream may be cycled proximate to the outlet from the reaction unit via periodically letting the pressure down, and then letting the pressure recover. A volume of inert solids are removed from the mixture fluid stream thereby creating a remaining combined gases and liquids fluid stream. Power is recovered from the remaining combined gases and liquids fluid stream. And, volumes of water, gas and oil are separated from the combined gases and liquids fluid stream.

The process and/or plant improves upon the discovery of the concept that supercritical water can be used to adsorb and break down organics like plastics or other large molecular species.

The embodiments disclosed as presented herein, help solve at least a part of the plastic waste recovery needs of the world.

This application, in its preferred embodiment, presents a robust process able to handle mixed wastes, and convert those wastes into products in a process that is fully heat integrated and energy integrated. This makes the process have very low operating costs, and to be economically viable in the marketplace of what will be multitudes of competing plants for the waste streams. It also achieves this using mostly available technology and equipment. One very highly specialized area relates to the recovery of energy in a supercritical fluid/liquid stream through a power recovery turbine, considering the very high pressure and temperature of that stream. The process also incorporates technology that keeps the reactor from fouling. Incorporated mineral materials from the plastics must be removed from the liquid before entering the recovery turbine, as described in paragraph [0013] above.

The process runs at high temperatures and pressures, and produces gases, and hydrocarbon products that must be separated and recovered, with the supercritical fluid being mostly recycled, and converted in every cycle from low temperature and low pressure to high temperature and pressure, and then back to the low side. Interchangers and heat conservation methods are shown throughout the process, which uses its gas production as the fuel source for most, if not all, of the heat needed to run the process. Cyclic swings in gas make based on varying feedstock wastes are accounted for in the process design, and excess gas if available can be compressed for sale as well, by adding a compressor.

This process is unlike pyrolysis that can also produce chemicals and fuel components. The hydrocarbons produced in pyrolysis are similar to those produced in the refining processes like visbreaking, thermal cracking, and other temperature processes, which are considered “wild” products. Such “wild” products require downstream treating like hydrotreating, Merox® washing, and other treatments to “tame” the fractions and to make them saleable, including the removal of sulfur and nitrogen. Merox® is a registered trademark for oxidation catalyst owned by UOP LLC.

By contrast, the supercritical extraction process produces products that have nil sulfur (S), and nil nitrogen (N), and therefore does not require hydrotreating or Merox® washing. There is a current desire for sulfur in fuels concentration to be continually diminishing in an attempt to reduce acid rain and deforestation. The nitrogen is a poison to hydrotreating, hydrocracking, and reforming catalysts that reduces yield and catalyst life. This supercritical extraction process produces products that are immediately useable to produce fuel grade products in normal refining operations. The product also has no 650F. plus fraction. Thus, product is a light syncrude that can allow refiners to increase operating profits by using it as a blend to lighten the crude feed gravity and allow the use of cheaper heavier crudes such as Bachaquero, and Maya, and others, to be used in combination with this blend stock. With no N or S, product from an embodiment of the process also allows the refiner to lessen the severity in their HDS and HTU units and prolong catalyst life. The diesel components of the produced hydrocarbons may be more paraffinic than those in the other crude feedstocks, which would increase Cetane Number in the pool, indicating a higher quality product.

### BRIEF DESCRIPTION OF THE DRAWINGS

The embodiments may be better understood, and numerous objects, features, and advantages made apparent to those skilled in the art by referencing the accompanying drawings. These drawings are used to illustrate only typical embodiments of this invention, and are not to be considered limiting of its scope, for the invention may admit to other equally effective embodiments. The figures are not necessarily to scale and certain features and certain views of the figures may be shown exaggerated in scale or in schematic in the interest of clarity and conciseness.

FIG. 1 depicts a schematic process and plant diagram of an exemplary embodiment of a heat and energy integrated continuous process for plastic waste recovery.

FIG. 2 depicts a schematic process and plant diagram of an exemplary embodiment of a heat and energy integrated continuous process for plastic waste recovery.

### DETAILED DESCRIPTION OF THE EMBODIMENT(S) SHOWN

The description that follows includes exemplary apparatus, methods, techniques, and instruction sequences that embody techniques of the inventive subject matter. However, it is understood that the described embodiments may be practiced without these specific details.

Supercritical water can effectively dissolve organics, including biomasses, lignites, brown coals, and polymers, and even lignins and paper and cellulose components. This discovery augments the dissolved products' chemistry (caps active ends) to be stable. Supercritical extraction is unlike the pyrolysis process that can also produce chemicals and fuel components, as earlier described, with the difference in product properties and inherent fuel quality limitations, described in paragraph [0019] above. There are several processes that make use of this discovery, for example, as mentioned in the references in the background section of this application. The exemplary embodiments presented herein all utilize the process improvements and equipment claimed herein to achieve an improvement in energy and heat usage to lower the operating costs of those improved processes versus their current embodiments.

More specifically, exemplary embodiments are keyed to improving processes, and their attendant economics, used for supercritical water extraction of plastic wastes.

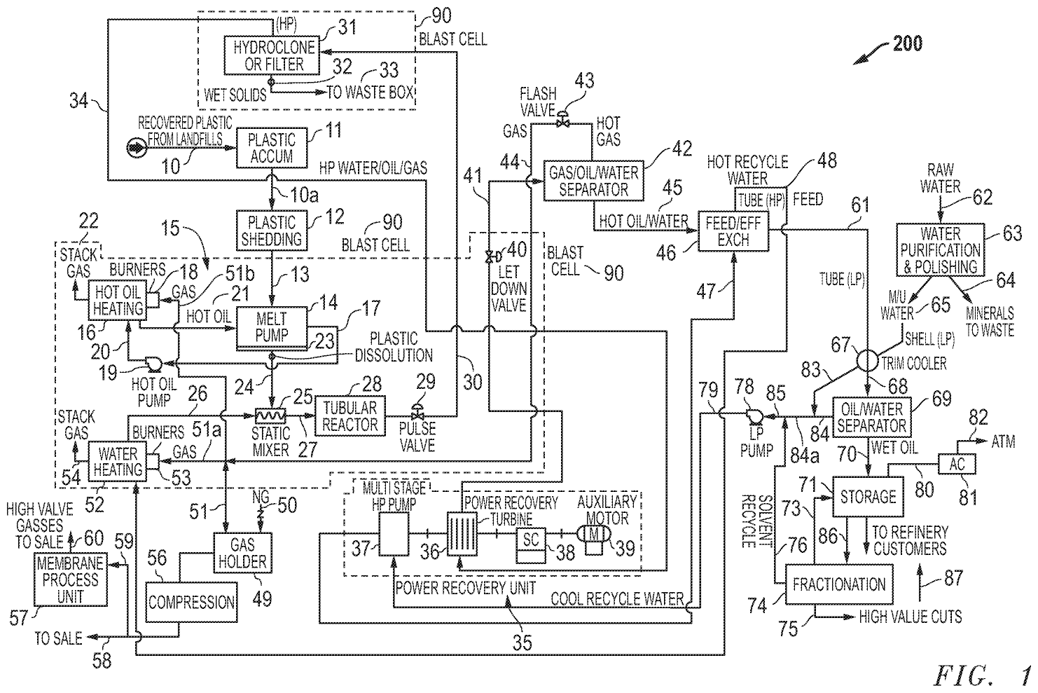

FIG. 1 depicts a process and plant (both referred to as “process” below) diagram of an exemplary embodiment of a heat and energy integrated continuous process for plastic waste recovery 200. Plastic wastes 10, which may be either mixed or segregated into recycle categories, but without any paper or other packaging, are received and stored onsite at a facility. These wastes 10 are fed (e.g. via a yard bulldozer) into the process 200 in a plastic accumulation set of bins or silos 11, and may be fed by, for example, mechanized equipment, belt conveyors, screw conveyors, elevators, etc. From that point, the wastes 10 may be fed into a day bin, for controlled feed into the process 200, by loss in weight feeders. The day bin may incorporate bar grates or other sieves to keep gross contamination out of the day bin.

The plastic waste feed 10a is shredded into smaller pieces, for example around 100 mesh up to 3-4 mesh size pieces, in a saw-tooth shredder, mill, or other suitable size reduction device 12. The shredded or reduced size plastic waste stream 13 passes to a melt pump 14. From the melt pump 14 onward, the process is considered to be a high pressure process that requires adequate safety barricades or blast cells 90 to prevent harm to the employees working there.

The melt pump 14 may be heated by a hot oil recirculation system 15. The hot oil recirculation system may pump an oil stream 20 through hot oil heater unit 16. Hot oil stream 21 heats melt pump 14 and oil stream 17 exits the melt pump 14. Oil stream 17 is pumped by hot oil pump 19. The hot oil heater unit 16 burners 18 for said system 15 uses gases 51b derived from the process 200, and may be supplemented by, for example, natural gas 50, or propane, if needed, to heat the oil 20 to temperatures needed to melt the plastic, for example, generally from 200F. to over 500F., if fluoropolymers were to be considered recyclable in the future. Stack gas 22 exits the hot oil heating unit 16.

The melt pump 14 also gets the plastic waste feed 10a up to pressure and is equipped with or mounted to a die plate 23 (shown mounted to the bottom of melt pump 14) to divide the molten plastic into several streams or multiple strands 24, at pressures exceeding 3000 psig up to 6000 psig (or even up to 10,000 psig). Extrusion via extruder (not shown but known to one skilled in the art) will not be necessary with melt pump 14. The melt pump 14 may be, as example only, a gear pump, or other type of positive displacement pump suitable for polymers in stainless steel, or other suitable materials of construction, equipped with a heating jacket suited to the use of heating oil. The melt pump 14 may be, alternatively, heated by electric heaters or other means of heating.

The several streams of melted plastic from the die plate 24 are introduced along the length of a high pressure static mixer 25, which must be of corrosion resistant material, and rated for pressures above those used in the reactor 28, for example, from 5000 to 8000 psig. The static mixer 25 may also serve to break apart incompletely melted waste feed.

The static mixer 25 contains stationary elements to combine the plastic streams 24 into a flowing stream of water 26 (tube side), or water plus co-solvent(s), at temperatures and pressures above the critical point of water in the range of 450 degrees C. to over 500 degrees C. Piping within a blast cell or containment 90 may be high pressure tubing rated to the service temperature and 1.5 times the operating pressure as burst pressure, minimum, in corrosion resistant material used for that type of service (no carbon steel). Such piping is readily available from all suppliers to the US Oil Patch in the Gulf of Mexico area, including HYDRIL Company, Parker Autoclave Engineers, GS-Hydro US Inc., and Worldwide Pipe and Supply.

The static mixed stream 27 is then introduced into a tubular reactor 28, which may be long—by way of example serpentine, looped, or stacked loop, and of varying length based on desired residence time in the reactor having at least one internal wall. Based on production rate, and the ratio of plastic to solvent which may be about or less than 44%, the ID and OD of the tubular reactor may vary for whatever the plant production rate would be rated for and the desired residence time in the reactor, which may be 30 minutes or less. In one exemplary embodiment, the ratio of plastic to solvent preferably may be about or less than 42%. For example, the reactor 28 may be as short as a few dozen meters for a small plant, up to several hundred or even 1000 meters, or more, for a very large scale unit, based on very long residence times (in one example, the passageway of the reactor may be 450 feet long, having a diameter of from 12-18 inches). By implication, the reactor may be several smaller size units, each a replicate of the next, if the stream from the mixer 27 were divided into several parallel reactors (not shown). The diameter of the passageway may vary and may assist to slow flow speed (by way of example only, to 0.5 feet/second) through the reactor 28 (with or without a desirable ratio of added water). U.S. Pat. Nos. 8,057,666 and 10,421,052 describe examples of reactors and the teachings of same are hereby incorporated by reference.

The tubular reactor 28 operates in a continuous flow fashion, and is insulated to maintain the temperature within it. The serpentine coils may be supported on a frame, so as to include as much length as possible, with multiple return bends, with the intent that the stream 27 enters at one end of the tube stack in up-flow fashion to the next unit of coils, entering at the bottom, in up flow fashion, so as to prevent the unit from being gas bound. The units can be protected with a single rupture disc, or multiple discs, so the final design adheres to the requirements of the operating company's standards or to OSHA and state law, if these are regulated.

The tubular reactor 28 must retain heat and pressure. In one exemplary embodiment the operating pressure of the reactor ranges between, e.g., 2800 and 5500 psig (or preferably 3200-5000 psig) and at temperature between, e.g., 400 and 550C. (or preferably 450-550C.), based on the feed plastics used versus the product slate desired in terms of boiling ranges, and liquid yield versus gas yield.

The reactor is equipped with a pulse valve 29 that periodically lets down the pressure in the reactor by, e.g., 100 to 550 psi, to speed up the flow of the supercritical fluid plastic and to do three separate things—(i) more intimately mix the plastic and solvent mixture than with a straight plug flow reactor, (ii) sweep the walls of the reactor to prevent plastic sticking to the walls, and (iii) keep the gases being made to stay in solution with the solvent and plastic mixture to prevent gas binding. Generally, the reaction of the supercritical water and co-solvents, if used, with plastics at temperature and pressures in the reactor, will convert the plastics into oils and gases, as well as solids/fillers as further described. The pulse valve 29 may be set at periodic times and/or according to various stages within the reactor 28. Use of such a pulse valve is advantageous for continuous flow reactor used in a process involving supercritical water.

The plastic processed/treated may not be an ideal plastic. Therefore, the fluid stream leaving the reactor 30 through the pulse valve 29 is introduced into a solids removal device 31 to remove any additives, fillers, binders, inerts, slip agents, flame retardants, salts, etc. that had been added to the plastics during their production. The device 31 is a high pressure device, able to accept a pulsing flow, and constructed of materials suited to the conditions as described above. Such devices may include, for example, hydroclones, swing basket filters, rotary strainers, media filters, rotary vacuum filters, etc.

The solids removed 32 are sent to waste box 33 for collection and disposal, and represent a fluid loss from the system. These wastes 32 may be further treated to recover the hydrocarbon oils from the solids by gravity, or by enhanced gravity such as spiral separators, batch pot distillation or other separation techniques able to be conducted at atmospheric temperatures, or slightly elevated temperatures.

The high pressure (HP) water/oil/gas mixture stream 34, now cleaned of solids, being at a pressure below that of the reactor due to line losses and change in pressure (delta P) across the solids removal device 31, and being at a temperature close to that of the reactor less heat losses through the insulation, is introduced into a power recovery unit 35, a unique feature of this design or exemplary embodiment. The high pressure mixture 34 (e.g. supercritical fluid) enters at 3000 to 5400 psig and flows across the turbine 36 to a downstream pressure set by a letdown valve 40 of between 10 and 100 psig (or down to near atmospheric pressure). The power recovery unit 35 includes a high pressure multistage centrifugal pump 37 capable of producing pressures 50 to 100 psig greater than the reactor pressure. The pump is driven by the recovery turbine 36 assisted in a constant speed control mode to match the pump curve for the desired flow and pressure, and augmented by an electric motor 39 that would provide additional power to control the pump speed in response to the speed control 38 (speed controller 38 may set the auxiliary motor 39 to correct speed). Power recovery efficiency may vary from 50 to 80 percent of input power (more preferably 70 to 80 percent of input power), and represent great savings to plant operating costs, particularly in areas with high electric rates. Several manufacturers, are capable of mechanically designing and building the mechanical components needed for this custom power recovery turbine for power recovery unit 35. However the implementation of power recovery unit 35 herein is unique and advantageous for the system requires the turbine to handle supercritical fluids, a combination of liquids and gases, high pressures, fluids susceptible to cavitation, and carrying compositions of these fluids based on the reactor feed.

Post the power recovery turbine, stream 41 is introduced into a gas/oil/water separator vessel 42 with a flash valve 43 to release the gases at high temperature and retain the water and oils, by way of example only, at between 25 to 100 degrees C. below the operating temperature of the reactor 28. The flashing lowers the temperature of the separator outlet by 25 to 100 degrees C. further. The mixture desirably now retains some heat but with reduced pressure.

The hot separator effluent stream 45, which is above the supercritical temperature, then goes through a feed/effluent exchanger 46 on the shell side. The exchanger may be, for example, tube within tube, tube sheet multi pass, or any other such design. The effluent 45 exchanges heat against the high pressure water and co-solvent stream 47 pressurized by the pump 37. Hot recycle water/feed stream 48 is heated in the tubes of a cabin or other type of tubular heater 52 rated for the pressures previously described. The fuel gas 51a for this heater 52 is the flash gas 44 from the separator 42, which is collected in a gas holder 49. The water heater 52 (e.g., for heating water to 300 to 550 degrees C.) has burners 53, and stack gas 54 exits water heating unit 52 (gas 54 may be used as component to create heat as needed within the process 200, thereby reducing the consumption of electricity to heat). Gas stream 51 may flow into or out of gas holder 49 (i.e. the process 200 makes its own gas/fuel). The pressure of the gas holder 49 is maintained constant by the addition of natural gas or propane 50 when the pressure drops, or by expansion of the gas holder when the pressure rises. This same fuel gas 51b is used to fire the hot oil heater 16 previously mentioned in the earlier paragraphs. If necessary, for example, due to high gas make, the product gas stream 59 could be separated using a membrane process via membrane process unit 57 to derive selected mixtures, or pure gases of higher value 60. The plant has a compressor unit 56 to pressurize that gas 59 to gas for sale 58, and a membrane separation process unit 57 may be added at the user's desire and relevant market conditions. Excess gas could also be burned in another heating device to produce steam for cogeneration of electricity, or for sale as steam.

The shell side of the exchanger is cooled against fresh water makeup (M/U) 65 used to account for the losses with the solids in an exchanger, and if needed, a trim cooler 67 against circulated cooling water to get cool oil/water stream 61 down to 5 degrees C. above ambient. By way of example only, trim cooler 67 may be two coolers, one with circulated loop. This cooled stream 68 is passed through a simple decanter or oil/water separator 69 to separate the oil 70 from the water 84. Some of the co-solvent, if used, may also go into the water stream based on partition coefficients dependent on exact process conditions, and be recycled with the water. As an example, distillation can be a continuous still or a batch still. Fresh water makeup stream 83, which is the freshwater make up stream 65 after ‘cooling’ the shell side of the exchanger, passes into or joins separated water stream 84 resulting in combined water stream 84a.

The raw water 62 may be processed through a water purification and/or polishing unit 63 consisting of, for example, demineralizers and Activated Carbon adsorbers with special high activity carbon in for removing hardness minerals, iron, and silica from the water 64 and to waste in order to prevent fouling of the turbine blades, and reactor walls.

The product oils 70 and product oils from storage 73 can remain blended, or distilled or fractionated 74 by feeding stream 86 into fractions or high value cuts 75, to refinery customers 87, as just mentioned. Solvent recycle stream 76 from distillation or fractionation unit 74 may join water stream 84a resulting in combined water and co-solvent stream 85. Low pressure (LP) pump 78 pumps cool recycle water back to the multi stage high pressure (HP) pump 37 of the power recovery unit 35. The product storage 71 tank has a conservation vent on it and may be equipped with carbon canisters 81, and/or vent condensers, to prevent vapor emissions. In the embodiment shown, by way of example, one method and/or devices for controlling vapor emissions is, namely, from product storage tank 71 flow line 80 leads to activated carbon filter/canister/device 81 in line to atmosphere 82. Product in storage 71 may be sold to refineries, may be used as feed to oil/water desalter at crude unit, and may be naphtha/diesel mix with nil S and nil N.

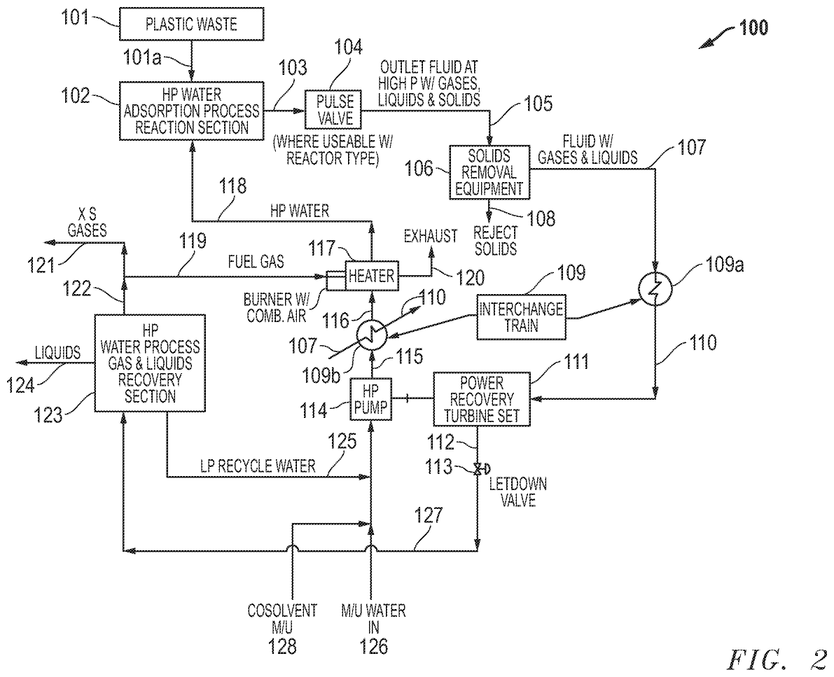

FIG. 2 depicts a schematic process and plant diagram of an exemplary embodiment of a heat and energy integrated continuous process for plastic waste recovery 100 (and in some manners generally overlapping with heat and energy integrated continuous process for plastic waste recovery 200 of FIG. 1). The plastic waste 101 is collected from various sources, and is reduced in size. Reduction in size may occur as described in FIG. 1. Reduced size plastic waste 101a may then be fed into a high pressure water adsorption process reaction unit or processing or section 102.

In high pressure water adsorption process reaction unit or processing or section 102, plastic waste 101/101a may be contacted with a combination of cosolvents, catalysts, and/or high pressure water stream 118, mixed together and reacted according to the process conditions. The type of reactor used, and the method of plastic introduction may vary. The outlet mixture 103 from the reactor 102 is at high temperature and pressure, up to and even above the supercritical temperature and pressure of water and/or the combined solvent fluid. The mixture fluid 103 contains gases, liquids and solids, that flow through pulse valve 104, where useable depending upon the reactor type. The pulse valve 104 allows the pressure to be cycled up and down (lowering and allowing pressure to recover) to keep the reactor walls clean.

The use of co-solvents in the high pressure water adsorption process reaction section 102 may improve the operating ratio of supercritical fluid to plastic so as to minimize the reactor and other equipment size in order to improve the capital costs of a processing plant. Co-solvents, for example, may be simple organic alcohols, or ketones, with boiling points, or specific gravities that lend themselves to easy separation and recovery from the aqueous phase, even though the co-solvents are miscible in water. International/PCT publication nos. WO2016/197180 and WO2009/015409 and U.S. Pat. No. 8,579,996 describe examples of co-solvents the teachings of which are hereby incorporated by reference including for definition of the term ‘supercritical’. The critical temperatures and pressures of such compounds are lower than those of water, so the percentage of co-solvent needed may be comparatively low or quite low to affect a significant change in hydrocarbon solubility and fracture into sub-components. The use of a co-solvent also lowers the mixture critical temperature and pressure and enables the reactor to run at lower pressures and temperature, which would be apparent in the overall energy and electrical demand of a processing plant. The use of co-solvents improves process selectivity, and allows for greater fuel and power efficiency as well. Other considerations factored into processing plant efficiency are the nature of the co-solvents used, the solvent to plastic ratio used, and the residence time of the reactor as installed.

The recycle water 125 may also include a co-solvent stream 128, if used based on the technology practiced.

The outlet stream 105, which comprises fluid at high pressure with gases, liquids, and solids, then passes to a solids removal equipment unit or processing or section 106. Solids removal equipment 106 may comprise special design filters, of swing basket design, or single filter design suitable for very high pressure, or very high pressure hydroclones, or very high pressure rotating strainers. These devices may require special designs for their gaskets, seals, vessel walls, and/or other features or attributes, etc. including the use of technology to handle dissolved gases, without gas binding the equipment, and high temperature metallurgy. Reject solids 108, are removed via the solids removal equipment section 106, and can be letdown by pressure reduction, or the filter may be backwashed to remove the solids, or the filter may be bled down in pressure to allow the device to be opened and the filter elements cleaned or replaced, depending upon the kind of filter used. Filters require special design and manufacture. High pressure swing basket strainers already exist, as do high pressure vessels with media, both of which are semi-continuous systems. It is preferred that the solids removal equipment section 106 includes the use of high pressure primary hydroclones, feeding secondary low pressure hydroclones. In one embodiment, the solids removal equipment section 106 may include use of a very high pressure continuous cleaning strainer, with division between high and low pressure zones incorporated, to allow backwash with low pressure water, while still processing (continuous) the high pressure water/oils/gas/cosolvent (if used) stream 105. In another embodiment cyclonic separation, either single stage or multistage. The filtering may be, by way of example only, either by batch method or continuously, with or without backwashing.

Fluid with only gases and liquids, both aqueous and organic, 107, still at high pressure and temperature (and in one exemplary embodiment still of a supercritical nature), passes through an interchange train 109 (generally cooling down from 7 to 10 and heating from 15 to 16). The fluid with only gases and liquids (combined gases and liquids fluid stream) 107 passes through interchange train 109 represented at interface symbol 109a into and through the tube side of the interchange exchanger train 109, where it is utilized to heat up the high pressure water flowing to reaction section 102. The high pressure water into the interchange train 109 is stream 115, and the preheated water is stream 116, differing only in the pressure and temperature of the streams. About 85%, or more, of the heat leaving the reactor section 102 is reclaimed in the interchange train 109. The cooled stream 110 from the interchange train 109 represented at interface symbol 109b is a cooled fluid with gases and liquids 110. Cooling the stream allows the gases to be better contained in the fluids, and preventing cavitation.

The interchange train 109 may be constructed from a variety of embodiments, including, but not limited to, shell in tube, tube in tube, plate exchanger, or U-tube. It may be multiple units in series to allow partial cooling down to meet the best needs of the power recovery turbine set.

Cooled stream 110 enters the power recovery turbine unit/processing section 111, which was described above with reference to FIG. 1 and reference number 35. The turbine section 111 may contain a set or any number of turbines and is represented schematically. The power recovery turbine unit 111 is driven via a letdown in pressure for stream 110 across the turbine blades, controlled by the letdown valve 113, as stream 112 exits the power recovery turbine unit 111. The reduced pressure and temperature stream 127 enters the high pressure water process gas and liquids recovery unit/processing section 123. The power recovery turbine section 111 includes a clutch to control speed and an auxiliary motor to keep the speed at the required value needed to run the high pressure pump 114.

In high pressure water process gas and liquids recovery unit 123, stream 127 in is letdown further in pressure, and the water is removed from the organic fluids by flashing off the gas, and by phase separation of the organic fluids from the water by gravity, or by enhanced gravity. The reclaimed water is recycled to the process as a relatively lower pressure recycled water stream 125, which is combined with any make-up water 126 needed for the process/plant 100. The water streams are pumped up to operating pressure by high pressure (HP) pump 114, powered by power recovery turbine set 111 with added co-solvent stream 128, if used, based on the exemplary embodiment of the technology practiced.

High pressure water process gas and liquids recover unit 123's flash gas may be compressed and stored. In this process improvement application, a portion of all of the gas 122 may be fed as the fuel gas stream 119 needed to run heater 117 is used to bring the water stream up to operating temperature for the reaction section 102, after the combined water stream of recycle and make up water is preheated via the interchange train 109 as previously explained. High pressure water stream 118 is that preheated water after trim heat is provided in heater 117. The excess gases 121 may be sold as product to customers of fuel gas. Exhaust gases 120 from heater 117 are vented to atmosphere.

Liquids 124 from section 123 may be further purified by distillation, extraction, adsorption, etc. to increase the quality of the streams to improve cut point, or remove impurities. As one example, see FIG. 1 description for purification of liquids. Any co-solvent absorbed into the oil stream would be a loss until or unless the product oil is distilled to remove the co-solvent from the product oil as known to one having ordinary skill in the art.

The general process, presented in FIG. 2, as well as the preferred embodiment presented in FIG. 1, includes the use of co-solvents (as described in U.S. Pat. No. 9,005,312 the teachings of which are hereby incorporated by reference), to improve the operating ratio of supercritical fluid to plastic, limited by other patent actions. This minimizes the reactor and other equipment size to improve the capital costs of the full scale plant. The cosolvents are simple organic alcohols, or ketones, with boiling points, or specific gravities that lend themselves to easy separation and recovery from the aqueous phase, even though the cosolvents are miscible in water. The critical temperatures and pressures of all of these compounds are lower than those of water, so the percentage of co-solvent needed will probably be quite low to effect a significant change in hydrocarbon solubility and fracture into sub-components. The co-solvent also lowers the mixture critical temperature and pressure and would enable the reactor to run at lower pressures and temperature, which would be apparent in the overall energy and electrical demand of the plant, as improved further by the process improvements presented in this patent application.

The process and plant 100 includes many advantages, namely, a continuous versus batch process, reactor improved mixing and wall cleaning, heat recovery, gas usage as fuel and as product, power recovery enabled by process water cleanup and solids removal, which also prevents reactor fouling, dewatering improvements, and power consumption reduction. Without these improvements or advantages use of this technology would be more expensive to use commercially, for both capital and operating costs. The use of co-solvents improves process selectivity, and allows for greater fuel and power efficiency in this type of process as well, when using the power recovery technology from this patent application.

The hydrocarbons produced can be separated by conventional technologies into various boiling point ranges, and purified by conventional techniques to those skilled in those arts.

While the exemplary embodiments are described with reference to various implementations and exploitations, it will be understood that these exemplary embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A heat and energy integrated method for plastic waste recovery having supercritical liquefaction, comprising the steps of:
a. processing a volume of plastic waste to produce a plastic waste stream;
b. adsorbing the plastic waste stream with a solvent comprising at least water, plus heating and pressurizing the plastic waste stream with the solvent into a supercritical extraction state in a reaction unit for converting the plastic waste stream into a mixture fluid stream of a supercritical nature within the reaction unit;
c. cycling the mixture fluid stream proximate an outlet from the reaction unit via periodically lowering a pressure of the mixture fluid stream and then recovering the pressure;
d. removing a volume of solids from the mixture fluid stream and thereby creating a remaining combined gases and liquids fluid stream;
e. recovering power from the combined gases and liquids fluid stream; and
f. separating volumes of water, gas and oil from the combined gases and liquids fluid stream.

2. The heat and energy integrated method for plastic waste recovery according to claim 1, wherein said step of recovering power from the combined gases and liquids fluid stream further comprises flowing the gases and liquids fluid stream across at least one turbine by letting down pressure downstream in the combined gases and liquids fluid stream.

3. The heat and energy integrated method for plastic waste recovery according to claim 1, wherein said heating of the solvent comprises using at least a portion of the volume of gas separated from the combined gases and liquids fluid stream as a fuel gas for running a heater.

4. The heat and energy integrated method for plastic waste recovery according to claim 3, further comprises using another portion of the volume of gas separated from the combined gases and liquids fluid stream as a product fuel gas.

5. The heat and energy integrated method for plastic waste recovery according to claim 1, wherein a ratio of the plastic waste stream to the solvent is less than or equal to about forty-two percent.

6. The heat and energy integrated method for plastic waste recovery according to claim 1, further comprising the step of melting the plastic waste stream prior to introducing into the reaction unit.

7. The heat and energy integrated method for plastic waste recovery according to claim 1, wherein said step of removing the volume of solids from the mixture fluid stream comprises removing by cyclonic separation.

8. The heat and energy integrated method for plastic waste recovery according to claim 1, wherein said step of removing the volume of solids from the mixture fluid stream comprises removing by filtering, wherein the filtering step is selected from the group of filtering steps consisting of batch method with backwashing, batch method without backwashing, continuously without backwashing, and continuously with backwashing.

9. The heat and energy integrated method for plastic waste recovery according to claim 1, wherein said step of adsorbing a solvent further comprises using additional co-solvents to improve an operating ratio of a supercritical fluid to the plastic waste stream in the supercritical extraction state.

10. The heat and energy integrated method for plastic waste recovery according to claim 1, further comprising the step of maintaining the mixture fluid stream in the supercritical state through the step of removing the volume of solids from the mixture fluid stream.

11. The heat and energy integrated method for plastic waste recovery according to claim 1, wherein said step of cycling the mixture fluid stream proximate the outlet from the reaction unit for periodically letting the pressure down further comprises cleaning an internal wall of the reaction unit and enhancing mixing of the solvent and the plastic waste stream.

12. The heat and energy integrated method for plastic waste recovery according to claim 1, further comprising the step of recovering heat from the combined gases and liquids fluid stream for heating the solvent.

13. The heat and energy integrated method for plastic waste recovery according to claim 12, wherein the step of recovering heat from the combined gases and liquids fluid stream for heating the solvent further comprises mixtures of cosolvents with the solvent.

14. The heat and energy integrated method for plastic waste recovery according to claim 1, further comprising the step of separating water from the combined gases and liquids fluid stream and using the separated water in said step of recovering power.

15. The heat and energy integrated method for plastic waste recovery according to claim 1, further comprising the step of dewatering the combined gases and liquids fluid stream.

16. A heat and energy integrated method for plastic waste recovery having supercritical liquefaction, comprising the steps of:
a. processing a volume of plastic waste to produce a plastic waste stream;
b. adsorbing the plastic waste stream with a solvent comprising at least water, plus heating and pressurizing the plastic waste stream with the solvent into a supercritical extraction state in a reaction unit for converting the plastic waste stream into a mixture fluid stream of a supercritical nature within the reaction unit;
c. cycling the mixture fluid stream proximate an outlet from the reaction unit via periodically lowering a pressure of the mixture fluid stream and then recovering the pressure, and further comprising cleaning an internal wall of the reaction unit and enhancing mixing the of the solvent and the plastic waste stream;
d. removing a volume of solids from the mixture fluid stream and thereby creating a remaining combined gases and liquids fluid stream;
e. recovering heat from the combined gases and liquids fluid stream for heating the solvent;
f. recovering power from the combined gases and liquids fluid stream, and further comprising flowing the combined gases and liquids fluid stream across at least one turbine by letting down pressure downstream in the combined gases and liquids fluid stream;
g. separating volumes of water, gas and oil from the combined gases and liquids fluid stream; and
h. wherein said heating of the solvent comprises using at least a portion of the volume of gas separated from the combined gases and liquids fluid stream as a fuel gas for running a heater

17. A heat and energy integrated apparatus for plastic waste recovery having supercritical liquefaction, comprising:
a. a means for processing a volume of plastic waste to produce a plastic waste stream;
b. a reaction unit connected to the processing means and receiving a solvent comprising at least water, and comprising means for heating, and means for pressurizing the plastic waste stream into a supercritical extraction state for converting the plastic waste stream into a mixture fluid stream;
c. a pulse valve connected to the reaction unit;
d. a means for removing a volume of solids from the mixture fluid stream connected to said pulse valve and thereby creating a remaining gases and liquids fluid stream;
e. a power recovery means connected to said means for removing the volume of solids; and
f. a separator and recovery unit connected to the means for heating, the separator for volumes of water, gas and oil from the gases and liquids fluid stream.

18. The heat and energy integrated apparatus for plastic waste recovery having supercritical liquefaction according to claim 17, further comprising a pressure let down valve connected downstream of said power recovery means.

19. The heat and energy integrated apparatus for plastic waste recovery having supercritical liquefaction according to claim 17, wherein said power recovery means further comprises a set of turbines.

20. The heat and energy integrated apparatus for plastic waste recovery having supercritical liquefaction according to claim 17, further comprising a volume of fuel gas from the separator and the volume of fuel gas feeding to the heating means.
